(19) United States
(12) Patent Application Publication
(10) Pub. No.: US 2002/0073343 A1
(43) Pub. Date: Jun. 13, 2002

(54) Integrated internet messenger system and method

(76) Inventors: Benjamin H. Ziskind, Falls Church, VA (US); Justin Fidler, Washington, DC (US); Christopher Burris, Washington, DC (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/735,467

(22) Filed: Dec. 14, 2000

Related U.S. Application Data
(60) Provisional application No. 60/170,529, filed on Dec. 14, 1999.

(51) Int. Cl. H04L 9/32

(52) U.S. Cl. 713/202

(57) ABSTRACT

A system capable of seamlessly integrating Internet messaging services with an “affiliate” Web site in which authentication and registration of each user takes place between Web servers, without the need for additional logon sequences with additional usernames and passwords, and is not detectable to the user. The messenger system also provides for customization of the messenger interface in a manner that helps to generate an appearance that is consistent with that of the affiliate site's. Additional customization features are also available such as ad frame space and language selection.

### CROSS-REFERENCE TO RELATED APPLICATION

This application claims priority from Provisional Patent Application number 60/170,529, filed Dec. 14, 1999, and entitled “Bantu Messenger Method and System.”

### BACKGROUND OF THE INVENTION

1. Field of the Invention

This invention relates to Internet communications, and more particularly, to Internet messenger systems and methods for providing an ideal user experience for end-users, minimizing authentication tasks and maximizing third-party branding.

2. Discussion of the Related Art

Internet messaging provides an Internet user the ability to communicate interactively over the Internet. Currently, many Internet messenger systems are available. Some of the most prevalent are ICQ, AOL Instant Messenger, MSN Messenger and Yahoo! Messenger. Many of these name brand messenger products are provided by the largest of the Internet Service Providers (ISP) or specific portal Web sites primarily engaged in Internet messaging. These products are generally available to Internet users who are not necessarily members of ISPs or Web sites providing messengers, but members of Internet services or provider sites (“affiliates”) with access to the branded messengers. In these cases, an affiliate user does not inherently belong to the messaging system and, therefore, must create an additional id and password to login to the messaging system. A disjointed user experience is created by necessitating such an additional login requirement.

In addition, affiliate sites where branded messengers are used, or even offered by the affiliate are left, at times, with the problem of distributing a product or having a product used in conjunction with their services that is created by, and boldly advertising a competing product or service. The user interface of the messenger application does not necessarily match that of the affiliate's system interface highlighting the inconsistency of the products, and adding to the disjointed presentation of a non-affiliate application. In addition, many Internet messengers include general advertising space on their user interface for which the affiliate would have no control, nor reap any advertising revenue benefit.

Further, some Internet messengers do not interact with, or, at best, interact poorly with all but the same brand Internet messenger. Each of the messengers also requires an individual user to install specific software onto his/her local computer (client computer) occupying valuable memory space when the messenger software is not in use.

### SUMMARY OF THE INVENTION

The present invention is directed to providing an innovative system and method for seamlessly invoking, logging into, and customizing the appearance and features of an internet messenger for an affiliate Web site.

It is therefore an object of the present invention to provide seamless integration of an Internet messenger with an affiliate site.

It is a further object of the present invention to provide, as part of the seamless integration, a method in which the user login process is not detectable by the user.

It is a further object of the present invention to provide a messenger that an affiliate site can customize with a unique interface, appearance and functionality in order to denote the affiliate as a co-brand with the source of the messenger, as well as maintain a consistent presentation with the affiliate's user interface.

A further object of the invention is to provide a messenger that an affiliate site can customize with ad banners.

It is also an object of the present invention to provide an Internet messenger system and method that does not install software on a client computer.

It is also an object of the present invention to interact with a wide variety of messengers.

Thus, in accordance with a first aspect of the invention, a messenger system is provided for seamlessly integrating a messenger product with affiliate sites. The system includes a messenger service provider service containing at least one Web server. At least one affiliate service capable of connecting with its users, and containing at least one Web server. A user with a client computer connected to the affiliate service. A customizable messenger product accessible by valid affiliate users. The system further includes a database, located on the messenger service provider site, containing user registration data, including usernames and passwords (or other similar authentication information), for each user of the Internet messenger. The database can also include optional information, such as demographic data. The affiliate site maintains a database containing affiliate user information. The affiliate site Web server is capable of generating dynamic Web pages, and is used to launch the messenger product transparently from the affiliate site. The affiliate Web server can also generate XML formatted packets for passing user registration data to the messenger service provider Web server (for authentication purposes).

The system further includes a unique co-brand identifier and a co-brand identifier string. The messenger service provider provides the affiliate a unique co-brand identifier for identification purposes when the messenger is launched. The affiliate site provides the messenger service provider with a co-brand_identity_string used to identify the affiliate's users as belonging to that particular affiliate throughout the messenger interface. The co-brand_identity_string is appended to the username in the form of: username@co-brand_identity_string. Typically, the co-brand identity string maps to the valid Internet domain name of the affiliate.

In accordance with a further aspect of the invention, a method is provided for the authentication and registration of affiliate users using an Internet messenger that takes place between the messenger service provider Web server and the affiliate Web server in a manner that is not visible to the user. First, an affiliate user attempts to launch the messenger product. This request prompts the affiliate site to submit a hidden form containing authentication information for that particular user, as well as some customization information unique to that affiliate site to the messenger service provider Web server which provides a messenger launch request. Upon receiving the information the messenger service provider queries the affiliate Web server for authentication information regarding that user, when such authentication information has not previously been validated. In this case, the affiliate's database is searched for the user's id and password through a request issued by the messenger service provider. An XML-formated data packet is returned to the messenger service provider Web server with the verification information. If the user is authenticated by the messenger service provider Web server the messenger is loaded onto the user's client computer.

If the user is not authenticated, steps are taken to determine whether or not the user should be registered on the messenger service provider database. First, the messenger service provider database is checked to determine if the user is listed. The affiliate site is then queried for additional information about this user id. If the user's name does not exist in the affiliate database, the user is not permitted access to the messenger service. Otherwise, the user's information is included or updated on the messenger service provider's database with the new information provided by the affiliate. The user and password information is once again checked against the messenger service provider's data base. If the information is still considered invalid the user is not permitted to logon to the messenger service. If the affiliate database verifies the user's credentials, then the user is authenticated by the messenger service provider Web server the messenger is loaded onto the user's client computer.

In a further aspect of the present invention, a method is provided for customizing the user interface. Customization features are used at the affiliate site's option. A default language (for the interface) can be requested (e.g., English, Spanish, French). The affiliate site can select a custom image to be displayed on their specific implementation of the messenger. The affiliate can also supply the messenger service provider with primary and secondary background color values for display on various messenger pages. The messenger service provider or the affiliate can design a custom “skin” to be used on the Messenger interface, wherein additional affiliate buttons and features can be provided to affiliate users. The affiliate can also have advertisements displayed within an ad frame on the Messenger interface, or remove the ad frame entirely. The affiliate may also choose a different set of advertisements to display, depending on the language the user is using the interface in.

### BRIEF DESCRIPTION OF THE DRAWINGS

FIG. 1 is a flow diagram of the messenger affiliate user transparent login method in accordance with an embodiment of the present invention.

FIG. 2 is a schematic diagram of basic system elements in accordance with an embodiment of the present invention.

### DETAILED DESCRIPTION OF THE PREFERRED EMBODIMENT

The present invention, referred to in this embodiment as Bantu Messenger, allows users to communicate with other users on bantu.com, other affiliates, as well as ICQ, Yahoo! Messenger, and MSN Messenger. Bantu.com, an example site, is merely illustrative of one implementation of the present invention, and the present invention is not intended to be limited to this particular site or example. Bantu Messenger is a thin-client, Java-based messenger with nothing to install on the client machine. This allows Bantu Messenger to be offered as a co-branded solution which integrates seamlessly with affiliate sites.

Customization features are also provided in the Bantu Messenger. These features can include, but are not limited to, language selection, a custom image, primary and secondary color selection, the ability to design a custom “skin,” and the ability to include ad banners.

According to a preferred embodiment, the affiliate site is able to choose which default language Bantu Messenger is displayed in by setting a language parameter when invoking the Bantu Messenger.

The affiliate site is also able to choose custom images to be displayed on their implementation of Bantu Messenger. The affiliate creates a 110 pixel (width) by 29 pixel (height) image as their logo images. The URL for this image is supplied to Bantu and displayed on the Bantu Messenger when launched by the affiliate's user.

Primary and secondary background colors (hex values) are supplied by the affiliate to Bantu for display on various Bantu Messenger pages.

A custom “skin” can also be designed by Bantu or the affiliate. This skin provides an interface for affiliate users with a custom look, including specific buttons available to the affiliate users. All these customizations can additionally be done on a language-by-language basis, recognizing that layouts might be slightly different depending on the language (usually due to the width of text in different languages, as well as character set limitations).

Ad space is also customizable. The affiliate has the ability to serve its own banner advertisements in an ad frame space on the Bantu Messenger. The affiliate simply supplies to Bantu the URL containing the ad serving code. The affiliate may provide a different set of advertisements by language, or opt to remove the ad frame entirely.

The system further includes a unique co-brand identifier and a co-brand identifier string. Bantu provides the affiliate a unique co-brand identifier for identification purposes when the messenger is launched. The affiliate site provides Bantu.com with a co-brand_identity_string used to identify the affiliate's users as belonging to that particular affiliate throughout the messenger interface. The co-brand identity string is appended to the username in the form of: username@co-brand_identity_string. Typically the co-brand identity string maps to the affiliate's Internet domain name.

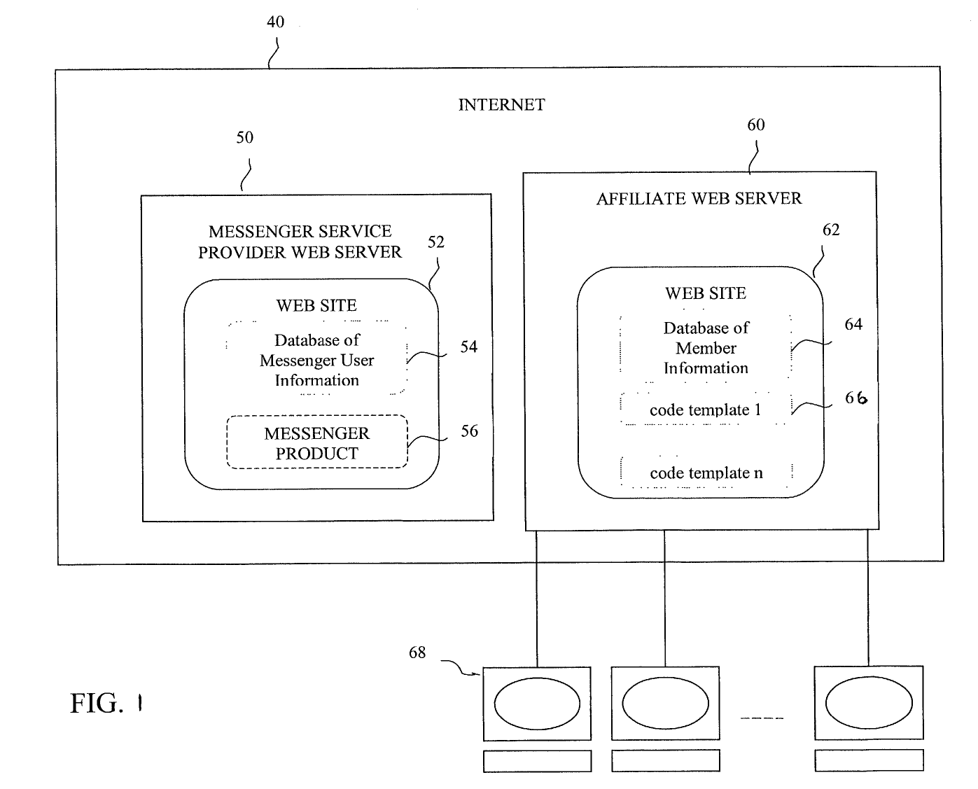

Referring to FIG. 1, a messenger system according to the present invention includes a messenger service provider located on the Internet 40 by maintaining a Web server 50. Included on the Web server 50 are a database 54 containing messenger user registration information and the messenger product 56.

The messenger system also includes at least one affiliate with an affiliate Web server 60 located on the Internet 40 capable of connecting to affiliate user computers 68. A database of affiliate member information 64, and various code templates 66 for communicating with the messenger service provider server 50 are also maintained on the affiliate Web server 60.

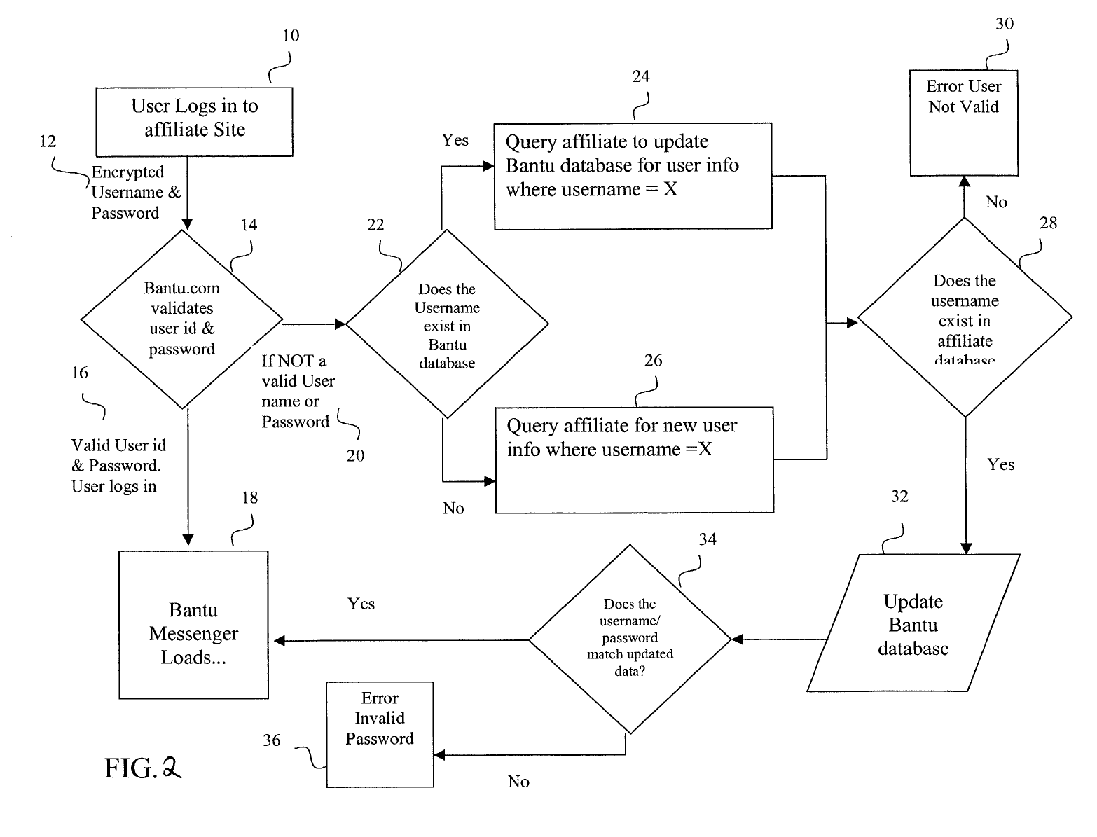

Referring to FIG. 2, the method of the present invention includes the steps as follows. A user of an affiliate Web site logs into that site's Web services, step 10, with the user's client computer, creating a connection between the Internet and the client computer from which the user can invoke the Bantu Messenger. The affiliate user launches the Bantu Messenger by clicking on a link. Upon launching the Bantu Messenger, a login request is made to the Bantu Web server via a document.form.submit function which is located on the affiliate site. This function submits a hidden form to Bantu.com requesting Bantu messenger services and includes customization information, such as default language. Bantu in turn queries a senduser script located on the affiliate Web server. The exact URL for this script is supplied to the messenger service provider by the affiliate site. In addition, the senduser script can also be protected by IP block and by a username and password. The affiliate database is searched for the user's id and password. An XML formatted data packet is returned to the Bantu Web server with verification information 12. The XML data packet of this preferred embodiment contains the following fields:

| | |
|---|---|
| CobrandID | The service provider supplied numeric site |
| | identifier. |
| UserLogonID | The logonID that users use to logon to the |
| | affiliate site |
| | note: This can only contain the characters |
| | A-Z, a-z, 0-9, and the underscore character |
| | “_” (max length is 60-[length of co- |
| | brand_identity_string] characters). |
| Cobrand UserID | The “affiliate” site's internal database user |
| | id for the user. [optional] |
| Password | The password associated with logonID |
| firstName | The user's first name (max length is 100 |
| | characters). |
| middleName | The user's middle name (max length is 50 |
| | character). [optional] |
| lastName | The user's last name (max length is 50 |
| | characters). |
| password_hint_question | A password hint question (max length 50 |
| | characters). [optional] |
| password_hint_answer | The answer to the password hint (max |
| | length 50 characters). [optional] |
| Language | The user's language preference (numeric |
| | value). [optional] |
| | Current Values: |
| | 1 = Language 1 |
| | 2 = Language 2 |
| | 3 = Language 3 |
| | 4 = Language 4 |
| | 5 = Language 5 |
| | 6 = Language 6 |
| ContactEmailAddress | A valid email address (for contact |
| | purposes) (max length 200 characters). |
| | [optional] |
| ContactUserPref | Single characters of ether B, N, or A |
| | Current Values: |
| | B = contact via. bantu.com mail |
| | A = contact via. contact e-mail |
| | Address |
| | N = never contact |
| LocationZipCode | User's zip code in the format of ##### or |
| | ######-####. Only for U.S. zipcodes. |
| | [optional] |
| LocationCity | User's city (max length 50 characters). |
| | [optional] |
| LocationState | User's state (max length 50 characters). |
| | [optional] |
| LocationCountry | User's country (2 char ISO country code). |
| | [optional] |
| gender | User's gender (single char of either M or F |
| | or X). Use value “X” if gender is |
| | unknown. |
| birthDate | User's birth date in MM/DD/YYYY |
| | format. [optional] |
| birthYear | User's birth year (4 digit year). |
| listingInUserDirectory | Public directory list flag (numeric 1 or 0). |
| | Set to “1” if the user should appear in |
| | listings of users who are online, or set to |
| | “0” is this is not desired. |

Unused optional fields are included in order to preserve the data structure. The Bantu Web server uses the data packet in attempting to validate the affiliate user id and password against the Bantu database, step 14. If the Bantu Web server validates the user id and password, the affiliate user is permitted access to the Bantu Messenger and it is loaded for use on the affiliate user's client computer, step 18.

If, however, the user id or password is not authenticated, step 20, steps are taken to determine whether or not the user should be registered, that is, included on the Bantu database. First, the Bantu database is checked to determine if the user exists, step 22. If the user is listed in the database, Bantu requests updated information from the affiliate when necessary to complete the authentication. If the username and password match what is in Bantu's database (so the authentication is valid), then the request for updated information will only be made if the affiliate has passed a parameter in the hidden form to indicate that an information update request is desired, step 24. If the user is not listed in the Bantu database, new user information is requested from the affiliate for that user, step 26. In both instances, it is determined whether or not the username exists in the affiliate database, if necessary or desired, step 28. Upon querying the affiliate database, if the user's name does not exist in the affiliate database, a “user not valid” error is generated and the user is not permitted to logon to the Bantu Messenger service, step 30. If the user's name does exist in the affiliate database, the user is registered, that is, Bantu's database is updated with the new information provided by the affiliate, step 32. The user and password information are once again checked against the Bantu database, step 34. If the information still does not match, an “invalid user” error is generated and the user is not permitted to logon to the Bantu Messenger service, step 36. If the user is authenticated by the Bantu Web server the Bantu Messenger is loaded for use onto the affiliate user's client computer, step 18.

The foregoing is merely illustrative of the principles of this invention and various modifications can be made by those skilled in the art without departing from the scope and spirit of the invention

What is claimed is:

1. A method for authentication and registration of messenger product users from an affiliated service provider that is not perceptible by the messenger product user, said method comprising the steps of:
launching the messenger product by a user from a client computer connected with the affiliate service provider;
querying, by the messenger service provider, an affiliate service provider server for user authentication data when necessary or desired;
returning, by the affiliate service provider server, the user authorization data to the messenger service provider server;
determining, by the messenger service provider server, the validity of the user authorization data; and
wherein if the user authorization information is determined to be valid, access is granted to the user by loading the messenger product on the user's client computer, and wherein otherwise a second query for authentication is made.

2. The method of claim 1, wherein the launching of the messenger product further comprises submitting a hidden form, from a document.form.submit function, or similar form submit function, on the affiliate site, to the messenger service provider, thereby generating a login request.

3. The method of claim 2, wherein the document.form.submit includes customization parameters.

4. The method of claim 1, further comprising the step of providing messenger customization parameters to the messenger service provider.

5. The method of claim 1, further comprising the step of providing messenger customization parameters to the messenger service provider, wherein said parameters are selected from the group consisting of:
custom image data;
custom background colors data;
custom skin data;
custom ad banner data; and
default language data.

6. The method of claim 1, wherein the querying authentication information on an affiliate service provider server comprises a query by the messenger service provider server to a senduser script located on the affiliate service provider server.

7. The method of claim 6, wherein the senduser script is protected by an IP block.

8. The method of claim 6, wherein the senduser script is protected by username and password.

9. The method of claim 1, wherein the user authorization data comprises a user name and password unique to the user.

10. The method of claim 1, wherein the user authorization data is encrypted.

11. The method of claim 1, wherein user authorization data is returned to the messenger service provider in XML format.

12. The method of claim 1, wherein the second query for authentication comprises:
comparing the user authorization data with a messenger service provider database;
requesting updated user information from the affiliated site, if user exists in the messenger service provider database, or requesting new user information from the affiliated site, if user does not exist in the messenger service provider database;
if user does not exist on the affiliated site, denying user access to messenger;
if user exists on the affiliated site, updating the messenger service provider database and compare the authorization data with the updated service provider database;
if the authorization data is not valid, denying the user access to messenger;
if the authorization data is valid, granting access to the user by loading the messenger product on the user's client computer.

13. A system for providing an affiliate user access to an Internet messenger, comprising:
a messenger service provider containing at least one Web server and a database containing user registration data, including usernames and passwords for each user;
at least one affiliate capable of connecting with affiliate users, containing at least one Web server, a database of affiliate user data and at least one code template;
an affiliate user with a client computer connected to the affiliate site;
a customizable messenger product accessible by affiliate users.
